(19) United States
(12) Patent Application Publication
(10) Pub. No.: US 2025/0112034 A1
(43) Pub. Date: Apr. 3, 2025

(54) WIDE-SIZE RANGE AERODYNAMIC FOCUSING LENS

(71) Applicant: Board of Regents of NSHE, on behalf of DRI, Reno, NV (US)

(72) Inventor: Xiaoling Wang, Reno, NV (US)

(21) Appl. No.: 18/905,015

(22) Filed: Oct. 2, 2024

Related U.S. Application Data
(60) Provisional application No. 63/587,196, filed on Oct. 2, 2023.

(51) Int. Cl. H01J 49/06

(52) U.S. Cl. CPC H01J 49/067

(57) ABSTRACT

A wide-size range aerodynamic focusing lens may include a virtual impactor comprising an inlet nozzle, a major flow tube, and a receiving nozzle. A wide-size range aerodynamic focusing lens may include a plurality of grouped focusing elements comprising a first focusing lens element group, a refocusing lens element group, and a second focusing lens element group, and. A wide-size range aerodynamic focusing lens may include an accelerating nozzle. A wide-size range aerodynamic focusing lens may include a plurality of spacers where the diameter ratio of the spacer proximal to a lens element can range from 2 to 20.

### CROSS-REFERENCE TO RELATED APPLICATIONS

This application claims priority through the applicant's prior U.S. Provisional Patent Application No. 63/587,196 entitled “WIDE-SIZE RANGE AERODYNAMIC FOCUSING LENS” filed on Oct. 2, 2023, which application is hereby incorporated by reference in its entirety.

### COPYRIGHT

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Briefly and in general terms, the present disclosure is directed to aerodynamic lenses, and more particularly, to an aerodynamic lens capable of effectively focusing particles in a wide range, whose focusable size range is approximately 10-10,000 nm.

### BACKGROUND

Aerosol mass spectrometers have been widely used for real-time, in-situ measurement of atmospheric aerosol chemical composition and physical properties. They have proven to be important tools to investigate aerosol processes and their effects on air quality, climate, and human health. A key component of modern aerosol mass spectrometers is the aerodynamic focusing lens (AFL) inlet. Traditional AFL uses a series of focusing orifices (lenses) to generate a low-diverging particle beam. It allowed particles to be efficiently delivered from ambient environments to the analysis region, typically at pressures 8-10 orders of magnitude below atmospheric. The AFL transmission efficiencies were 3-6 orders of magnitude higher than those of conventional supersonic nozzles. The narrow beam ensured that particles passed through the most intense portion of the laser.

Conventional AFLs have typically focused approximately a factor of ten particle size range (e.g., from 30 nm to 300 nm). This often resulted in aerosol mass spectrometer measurements providing an incomplete picture of aerosol composition due, at least in part, to the limited size range being measured. One approach to mitigating this problem was to provide different AFLs to cover different size ranges. However, this alternative introduced a further problem, namely, switching lenses during measurement was time consuming and could lead to missed observation opportunities if particles were changing. Additionally, it could increase the risk of damaging the AFLs, aerosol mass spectrometers, or both.

AFLs typically focused only a portion (e.g., 30-600 nm) of the atmospheric particle size range of interest (approximately 1-10,000 nm). Transmission efficiencies and beam diameters deteriorated quickly for particles outside this range, missing many aerosols such as newly nucleated nanoparticles (≲10 nm) and larger particles (≳1 μm) such as sea salt and mineral dust. As a result, traditional aerosol mass spectrometer measurements provided an incomplete picture of aerosol processes due, at least in part, to the limited size range being measured. Different AFLs have been designed to cover different size ranges. However, switching AFLs is impractical in most applications, because it requires breaking vacuum and realigning the lenses, which can take several hours.

Referring now to Table 1 herein, most AFLs were optimized to cover approximately one decade of particle sizes. The PM_{2.5} (particulate matter with aerodynamic diameter ≤2.5 μm) AFLs (e.g., see Table 1 #7-#9) do not adequately focus particles smaller than approximately 100 nm. There is a need to for an AFL that focuses a wider size range, e.g., a true PM_{2.5} AFL with efficiencies >50% for ˜10 nm-2.5 μm particles with the possibility of extension to a 10 μm upper limit.

One standard design (e.g., see Table 1 #1) focused approximately 60-700 nm particles. This design has been used in many aerosol mass spectrometers, such as the Thermal Desorption Particle Beam Mass Spectrometer (TDPBMS), Aerodyne Aerosol Mass Spectrometers (AMS), Aerosol Time-of-Flight Mass Spectrometer (ATOFMS), and SPLAT series. These AFLs typically operated at ˜0.1 L/min flow rate with a pressure of ˜200 Pa before the first lens. Five lenses with aperture diameters of 5, 4.8, 4.5, 4.3, and 4 mm have been used to achieve >50% transmission efficiencies (in AMS) for particles with a vacuum aerodynamic diameter (dᵥₐ) range of ˜60-700 nm. Particles outside this range typically had much lower transmission efficiencies because they were either lost to walls during transport, or not well focused and missed the detector.

| AFL | d_{f} (mm)^{†} | dₙ (mm)^{†} | P (Pa)^{†} | dᵥₐ (nm) | Comment |
|---|---|---|---|---|---|
| #1 | 5*, 4.8, 4.5, 4.3, 4.0* | 6→3 | 200 | ~60-700 | Standard inlet for TDPBMS, |
| | | | | | AMS, ATOFMS, and SPLAT |
| #2 | 1.26, 1.64, 2.33 | 6→2.76 | 528 | 3-30 | Nano lenses using helium |
| #3 | 2.47, 3.07, 3.94, 4.99 | 5.65 | 324 | ~4-60 | Nano lenses used in NAMS |
| #4 | 1.24, 1.82, 2.42 | 2.72 | 880 | 10-100 | Converging-diverging orifices |
| | | | | | operating at higher Re and Ma |
| #5 | 1.4, 1.2, 1.0, 0.8, 0.7, | 0.65 or 0.4 | 2000-10640 | 300-3600 | Small orifices and high Re make |
| | 0.6, 0.5 | | | | the lenses sensitive to alignment |
| #6 | 0.75, 0.65, 0.55, 0.45, | 0.4 or 0.25 | 4000-23275 | | and manufacturing imperfections |
| | 0.37, 0.31, 0.25 | | | | |
| #7 | 5.11, 4.24, 3.52, 2.93, | 7.6→1.48 | 660 | 100-3000 | Lens inlet AFL-100 for the TSI |
| | 2.46 | | | | ATOFMS |
| #8 | 2.25, 2.02, 1.80, 1.57, | 1.8→0.9 | 1840 | 80->3000 | AMS high pressure lens; poor |
| | 1.35, 1.12, 1.01 | | | | reproducibility |
| #9 | 5*, 4.8, 4.5, 4.3, 4.0* | 6→1.6 | 507 | 110-3500 | AMS intermediate pressure lens |

^{†}d_{f}: lens aperture diameters; dₙ: accelerating nozzle diameters (“→” indicates a step or conical nozzle); P: pressure upstream of the first lens.
dᵥₐ: vacuum aerodynamic diameter.
*lenses with * are 10 mm-long capillaries.

Due, in part, to an increased interest in the chemical composition of ultrafine particles (UFP; ≳100 nm), several AFLs were designed to focus UFP. To account for the low inertia and high diffusivity of UFP, an AFL (e.g., see Table 1 #2) which attempted to optimize for 3-30 nm particles and demonstrated its performance via computational fluid dynamics (CFD) simulations and experimental tests (e.g., see U.S. Pat. No. 7,476,851). However, this AFL used helium as the carrier gas, which was not compatible for atmospheric aerosol measurement. A nanoparticle AFL (e.g., see Table 1 #3) designed for sub-30 nm particles in air or argon was used in the nanoparticle aerosol mass spectrometer (NAMS) to study nanoparticle chemical compositions and secondary organic aerosol (SOA) formation. It was noticed that the optimal Stokes number (Stₒ) was smaller at higher flow Reynolds numbers (Re) and Mach numbers (Ma) so an attempt was made to design an AFL (see e.g., Table 1 #4) to focus 10-100 nm nanoparticles in air. Converging-diverging orifices were used to stabilize flow and reduce shock wave impacts at the higher Re and Ma conditions. However, the simulation used laminar flow model and the performance of this AFL has not been validated.

Chemical composition of PM_{2.5} is regulated by national ambient air quality standards. There have been efforts to extend the AFL focusing range up to 2.5 μm. Several AFLs have been developed (see e.g., Table 1 #5 and #6) to try to optimize for stratospheric aerosol measurement. AFL #5 in Table 1 operated at high pressures (˜2,000-10,000 Pa) and used 7 lenses with aperture diameters from 1.4 to 0.5 mm to focus particles in the dᵥₐ range of ˜300 nm-3.6 μm. The small apertures and high Re often resulted in inconsistent focusing performance. An AFL (#7 in Table 1) was designed that focused 100 nm-3 μm particles with >50% transmission efficiency when used as an inlet (TSI AFL-100) for the TSI ATOFMS. However, another AFL (TSI AFL-050) was needed to cover the smaller particle size range (˜30-500 nm). An AFL (Table 1 #8) interfaced with the AMS showed transmission efficiencies >50% from ˜80 nm to >3 μm. However, this AFL tended to exhibit poor reproducibility. Recently, a smaller accelerating nozzle (1.6 mm) was used in the AMS standard AFL (see. e.g., Table 1 #1; with a 3 mm nozzle), which increased the operating pressure from ˜200 Pa to ˜500 Pa, and yielded AFL (see e.g., Table 1 #9) transmission efficiencies >50% for ˜110 nm to 3.5 μm particles.

There were many attempts to use multiple lenses to cover different size ranges. For example, TSI Inc. offered a standard AFL (see e.g., Table 1 #1) to cover ˜60-700 nm, and another AFL (see e.g., Table 1 #7) to cover 100-3000 nm. Aerodyne Research, for example, has also used AFL #1 as a standard lens. Historically, lens aperture diameters usually had decreasing orifice diameters, and the diameter ratio of spacers to lenses were usually larger than 4.

### SUMMARY OF THE INVENTION

This disclosure describes a wide-size range AFL that focuses particles with an aerodynamic diameter range approximately from 10 nm to 10,000 nm into a tight beam, which can allow mass spectrometers to provide near-complete or complete pictures of aerosol compositions, processes, or both. Conventional AFLs focus a narrow range of particle sizes, requiring switching multiple AFLs to cover different size ranges, which can waste time and can result in missed opportunities to observe aerosol composition changes. The wide-size range AFL uses one assembly to cover the entire size range of interest. Such a wide focusing range can be achieved via one or more of the dimensions and arrangement of the virtual impactor entrance, focusing lens elements, spacers, and accelerating nozzle. This further provides increased versatility for other applications that involve generation of particle beams, with one AFL capable of focusing a wide size range.

One advantage as compared to conventional AFLs is that, in some embodiments, the wide-size range AFL focuses a particle size range that is 10 to 100 time wider (see performances of conventional AFLs and related publications in Table 1). The wide-size range AFL increases the focused size range to a factor of 100 to 1000 (e.g., approximately from 10 nm to 10,000 nm), enabling mass spectrometers to provide complete or near-complete pictures of aerosol compositions and processes.

One or more of the advantages of the wide-size range AFL disclosed herein are obtained, at least in part, by one or more of (i) the separation the lenses into multiple groups, such as, for example, three groups, four groups, or the like, such as a larger particle size range group, a refocus group, such as a refocus of largest particles group, and smaller particle size range group, (ii) selection of lens diameters to focus targeted size range, (iii) design of the accelerating nozzle step to refocus the largest particles, and (iv) using a virtual impactor to increase the number of larger particles entering the lenses.

While convention lenses also use a series of orifices installed in a tube, separated by spacers to create a converging and diverging flow pattern to focus particles, the wide-size range AFL disclosed herein introduces and arranges lenses by groups, each tailored for focusing or refocusing a range of particles, such as, for example, a first group for the largest portion of the particle size range (e.g., 10,000-1,000 nm), a second group to focus middle size range of particles (e.g., 1,000-100 nm), a third group for refocusing the largest particles (e.g., 10,000-2,500 nm) that are defocused in a preceding lens group, and a fourth group for the smallest size range of particles (e.g., 100-10 nm). In contrast to conventional approaches that usually use the diameter ratio of spacers to lenses larger than 4, the ratio can be less than 4 in the wide-size range AFL. Each lens diameter can be optimized for focusing a range of particle sizes and each lens diameter can be larger or smaller than the neighboring lenses. This implementation is more robust and less restrictive than conventional designs, which typically had a group of reducing lens diameters and sometimes with another group with increasing lens diameters. A group can include a single lens or multiple lenses.

Conventional lenses further typically used cylindrical spacers and thin plate orifice lenses. The wide-size range AFL disclosed herein can use a range of lens geometries (e.g., thin plate orifice, short capillary, and conical orifice) and spacers (e.g., cylindrical, divergent, and divergent/convergent). This approach not only offers flexibility, but also allows for optimizing focusing performance. For example, the divergent/convergent spacer can reduce the flow recirculation, make beams more stable, or both.

In some instances, the accelerating nozzle disclosed herein can provide additional focusing of particles. The AFL accelerating nozzle controls, at least in part, one or more of the AFL internal pressure, particle beam shape, and terminal velocities in the vacuum chamber. The nozzle can have a smaller diameter aperture than the lenses, and therefore, can focus smaller particles, defocus larger particles, or both. The higher Re at the nozzle may generate turbulence, dispersing the particle beam. In some embodiments, an accelerating nozzle uses a step nozzle with a step diameter at or near half of the preceding spacer diameter along with a thin plate (e.g., 0.25 mm thickness) orifice exit. In some embodiments, the step diameter can range from the exit nozzle diameter to the upstream spacer diameter, with the step diameter being approximately half of the upstream spacer diameter being near optimum. The step can refocus larger particles, while the thin plate orifice exit can provide additional focus of smaller particles. Other geometries (e.g., conical step and thin plate orifice, straight step and short capillary, and conical step and conical orifice) and dimensions of the nozzle can be used for more stable flow, better focusing, or both.

A virtual impactor entrance increases the number of particles entering an AFL. Unlike conventional AFLs that used a critical orifice as an entrance, which often led to particle losses, orifice blockage, or both, the virtual impactor disclosed herein can one or more of use larger orifices to reduce the possibilities of blockage, enrich larger particles, allow for more particles to enter the AFL. In some instances, the virtual impactor disclosed herein include an inlet nozzle, receiving nozzle, and major flow tube, with the nozzles being orifices or conical nozzles.

In some aspects, the techniques described herein relate to a wide-size range aerodynamic focusing lens, including: a virtual impactor including an inlet nozzle, a major flow tube, and a receiving nozzle; a plurality of grouped focusing elements including a first focusing lens element group, a refocusing lens element group, and a second focusing lens element group, and; and an accelerating nozzle.

In some aspects, the techniques described herein relate to a wide-size range aerodynamic focusing lens, wherein the first focusing lens element group includes one or more particle focusing lenses focusing a first size range particle.

In some aspects, the techniques described herein relate to a wide-size range aerodynamic focusing lens, wherein the second focusing lens element group includes one or more particle focusing lenses focusing a second size range particle.

In some aspects, the techniques described herein relate to a wide-size range aerodynamic focusing lens, wherein the refocusing lens element group includes one or more particle focusing lenses refocusing the first size range particle.

In some aspects, the techniques described herein relate to a wide-size range aerodynamic focusing lens, wherein a particle enters the refocusing lens element group after passing through the first focusing lens element group and before entering the second focusing lens element group.

In some aspects, the techniques described herein relate to a wide-size range aerodynamic focusing lens, wherein the accelerating nozzle includes a step nozzle, the step nozzle including a step diameter equal to approximately half a preceding proximal spacer diameter.

In some aspects, the techniques described herein relate to a wide-size range aerodynamic focusing lens, wherein the step is a large particle refocusing step.

In some aspects, the techniques described herein relate to a wide-size range aerodynamic focusing lens, wherein the accelerating nozzle includes a thin plate orifice exit.

In some aspects, the techniques described herein relate to a wide-size range aerodynamic focusing lens, wherein the thin plate orifice exit is a small particle focusing exit.

In some aspects, the techniques described herein relate to a wide-size range aerodynamic focusing lens, including: a virtual impactor including an inlet nozzle, a major flow tube, and a receiving nozzle; a plurality of grouped focusing elements including a first focusing lens element group, a second focusing lens element group, and a refocusing lens element group, and a third focusing lens element group; and a plurality of spacers wherein a diameter ratio of a spacer proximal to a lens element is greater than or equal to 2 to and less than or equal to 20.

In some aspects, the techniques described herein relate to a wide-size range aerodynamic focusing lens, wherein first focusing lens element group focuses a plurality of particles of larger size than the second focusing lens element group.

In some aspects, the techniques described herein relate to a wide-size range aerodynamic focusing lens, wherein third focusing lens element group focuses a plurality of particles of smaller size than the second focusing lens element group.

In some aspects, the techniques described herein relate to a wide-size range aerodynamic focusing lens, wherein the refocusing lens element group focuses a plurality of particles of similar size to the first focusing lens element group.

In some aspects, the techniques described herein relate to a wide-size range aerodynamic focusing lens, wherein the plurality of particles includes particles between 1,000 nm and 10,000 nm.

In some aspects, the techniques described herein relate to a wide-size range aerodynamic focusing lens, wherein the plurality of particles includes particles between 10 nm and 100 nm.

In some aspects, the techniques described herein relate to a wide-size range aerodynamic focusing lens, wherein the second focusing lens element group focuses a plurality of particles including particles between 100 nm and 1,000 nm.

In some aspects, the techniques described herein relate to a wide-size range aerodynamic focusing lens, wherein the plurality of particles includes particles between 2,500 nm and 10,000 nm.

### BRIEF DESCRIPTION OF DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a schematic diagram of the wide-size range AFL.

FIG. 2 is a diagram of aerodynamic focusing.

FIG. 3 is a diagram of 900 nm particles through an AFL with five focusing lenses.

FIG. 4 is a diagram of an example of a wide-size range AFL with nine lenses and an accelerating nozzle.

FIG. 5 is a diagram of a flat orifice visual impactor design.

FIG. 6 is a diagram of a converging/diverging nozzle visual impactor design.

FIG. 7 is a diagram of a thin plate flat orifice lens geometry design.

FIG. 8 is a diagram of a short capillary (thick) orifice lens geometry design.

FIG. 9 is a diagram of a conical orifice lens geometry design.

FIG. 10 is a diagram of a cylindrical spacer design.

FIG. 11 is a diagram of a divergent spacer design.

FIG. 12 is a diagram of a divergent/convergent spacer design.

FIG. 13 is a diagram of a straight step and thin plate orifice accelerating nozzle.

FIG. 14 is a diagram of a conical step and thin plate orifice accelerating nozzle.

FIG. 15 is a diagram of a straight step and short capillary accelerating nozzle.

FIG. 16 is a diagram of a conical step and conical orifice accelerating nozzle.

### DETAILED DESCRIPTION

The applicant believes that it has discovered at least one or more of the problems and issues with system noted above as well as advantages variously provided by differing embodiments of the wide-size range AFL disclosed in this specification.

The various features and advantages of the systems, devices, and methods of the technology described herein will become more fully apparent from the following description of the implementations illustrated in the figures. These implementations are intended to illustrate the principles of this disclosure, and this disclosure should not be limited to merely the illustrated examples. The features of the illustrated implementations can be modified, combined, removed, and/or substituted as will be apparent to those of ordinary skill in the art upon consideration of the principles disclosed herein.

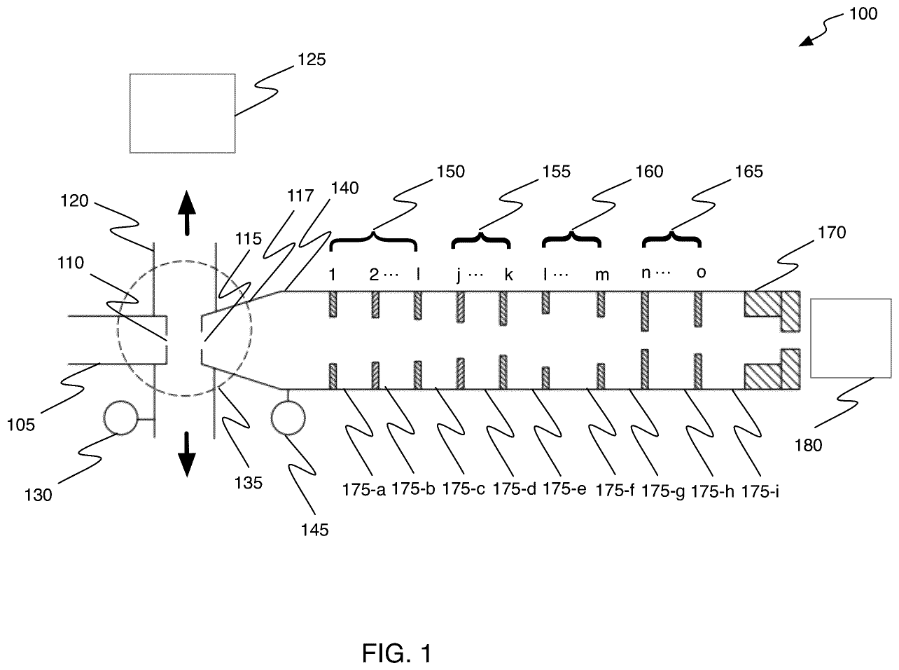

Referring now to FIG. 1, in some embodiments, the wide-size range AFL includes one or more of the following:

(1) An inlet tube 105 operable to transport particles from the sampling environment to the wide-size range AFL inlet nozzle 110.

(2) An inlet nozzle 110 operable to accelerate particles so that they can enter the receiving nozzle 115, and to control total sampling flow rate.

(3) A major flow tube 120 and corresponding flow control and vacuum pump 125 operable to pump away a portion, such as a majority, of the flow.

(4) A first pressure gauge 130 operable to measure pressure in the major flow to control major flow rate and pressure.

(5) A receiving nozzle 115 operable to accept particles from the inlet nozzle 110 to be focused by the lenses 150, 155, 160, 165.

(6) A virtual impactor 135, formed by the inlet nozzle 110, major flow tube 120, and receiving nozzle 115, operable to increase the efficiency of delivering particles into the lenses 150, 155, 160, 165.

(7) A relaxation chamber 140 operable to deaccelerate particles so that they are equilibrated with the flow before entering the lenses 150, 155, 160, 165.

(8) A second pressure gauge 145 operable to measure pressure in the relaxation chamber 140, which is the lens upstream operating pressure.

(9) Lens group 1 (1 to i) 150: aerodynamic focusing elements to focus the largest portion of the particle size range (e.g., 10,000-1,000 nm).

(10) Lens group 2 (j to k) 155: lenses to focus the middle size range of particles (e.g., 1,000-100 nm).

(11) Lens group 3 (l to m) 160: lenses refocus the largest particles (e.g., 10,000-2,500 nm) that were defocused in lens group 2 155.

(12) Lens group 4 (n to o) 165: lenses to focus the smallest size range of particles (e.g., 100-10 nm).

(13) An accelerating nozzle 170 operable to refocus larger particles and control one or more of pressure in the lenses 150, 155, 160, 165, flow into the vacuum chamber 180, and final speed and beam shape of particles.

(14) Spacers 175 are operatable to provide space between lenses for the flow to form a converge and diverge pattern, driving the separation of particles from fluid flow due to their inertial differences.

In some embodiments, aerosol particles are sampled from the environment into the inlet tube 105. The inlet nozzle 110 (can be, for example, a conical nozzle, a flat plate orifice, or the like) of the virtual impactor 135 accelerates particles to obtain higher velocities so that they can enter the receiving nozzle 115 and receiving tube 117 of the virtual impactor 135. The majority of the flow and a fraction of small particles are pumped away via the major flow tube 120. The flow rates through the major flow tube 120 and the receiving tube 117 are controlled by the diameters of inlet nozzle 110 and receiving nozzle 115, as well as the pressure between the two nozzles 110, 115. These parameters, along with the nozzle shape, nozzle diameter ratio, and distance between the inlet nozzle and the receiving nozzle determine, at least in part, the fraction of particles of each size entering the receiving tube. An example of the virtual impactor design consists of a 0.33 mm diameter metal orifice inlet nozzle, a 1 mm diameter conical receiving nozzle, separated by a distance of 0.6 mm. The pressures can be adjusted to achieve a major and minor flow rates of 0.8 and 0.1 L/min, respectively. The virtual impactor 135 (including the inlet nozzle 110, major flow tube 120, receiving nozzle 115, and receiving tube 117) can one or more of increase the particle transport efficiencies into the lenses, and concentrate particles for sizes larger than its cut-off diameter. As particles entering the receiving tube can have high velocities, they can be slowed down in the relaxation chamber to be equilibrated with the gas flow speed before entering the lenses.

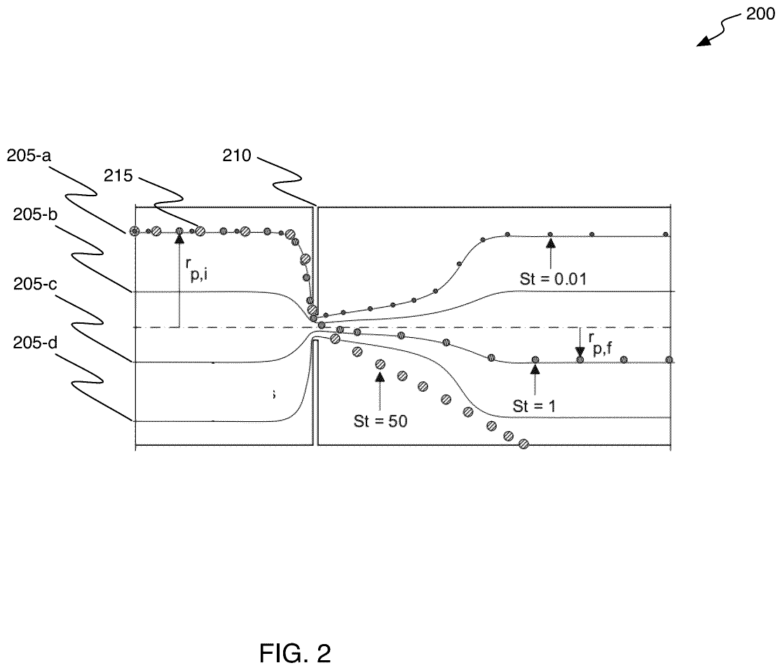

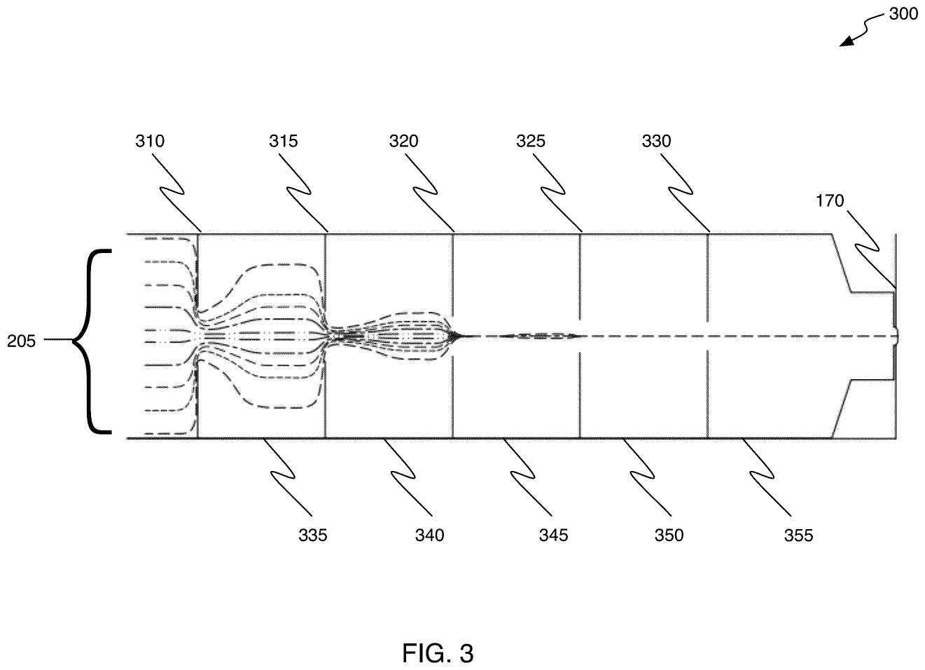

Referring now to FIG. 2 and FIG. 3, an AFL separates particles from the carrier gas using their inertial differences. Flow streamlines 205 converge and diverge when they go through an orifice (lens) 210. Particle trajectories 215 deviate from flow streamlines depending on the Stokes number (St), which is the ratio of the particle inertia to the drag force. For thin plate orifices, there exists an optimum Stokes number (Stₒ) with values close to one for which particles are focused along the axis. Small particles (St«1)) follow gas streamlines and are not focused whereas large particles (St»1) are defocused by the lens. The degree of focusing is characterized by the contraction factor (η_{c}), which is ratio of the particle terminal (r_{pf}) and initial (rₚᵢ) radial positions. An AFL uses several orifices in series 310, 315, 320, 325, 330 separated by spacers 335, 340, 345, 350, and 355, so that particles with a wide size range can be progressively moved closer to the axis.

In some embodiments, the group 1 lenses focus the largest size portion of the particles (e.g., 10,000 nm to 1,000 nm) to prevent them from becoming defocused and impacting on walls. The group 2 lenses continue to focus the middle size range of particles (e.g., 1,000-100 nm). The lenses can have the same or decreasing orifice sizes to focus progressively smaller particles. As some of the largest particles (e.g., 10,000-2,500 nm) will become defocused in the later lenses in group 2, they can be brought back close to the axis before they impact on the walls and become removed from the flow. The group 3 lenses refocus these larger particles. Group 4 lenses continue to focus the smaller particle size range (e.g., 100 to 10 nm).

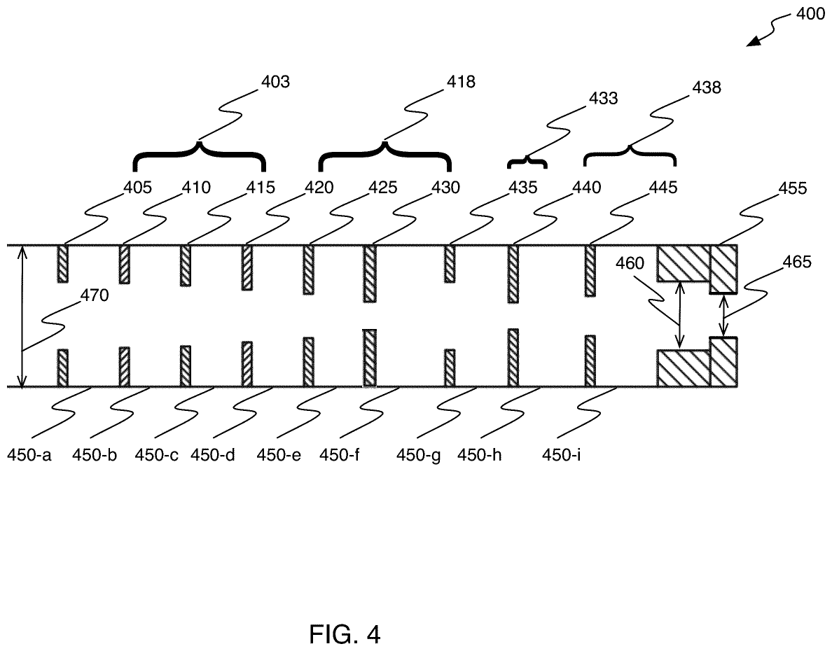

Referring now to FIG. 4, an example of the wide-size range AFL designs is shown. Group 1 403 includes lenses #1-3 405, 410, 415, all with a lens diameter of 3.48 mm, that focus 10,000-2,500 nm particles. The group 2 lenses 418 include lenses #4-6 420, 425, 530, which have diameters of 2.90 mm, 2.74 mm, and 1.72 mm respectively, that effectively focus 1,000-100 nm particles, but may defocus larger particles. The group 3 lens 433 is a single lens #7 435 with a diameter of 3.48 mm that refocuses these larger particles defocused by the previous lens group 418. This lens diameter is set to be the same as the group 1 lenses 403 to make them interchangeable. The group 4 lenses 438 included lens #8 and lens #9 440, 445, which effectively focus particles smaller than 100 nm. This particular design is for an AFL outer diameter of 12.7 mm (0.5 inch). The spacers 450 have an inner diameter of 8.4 mm 470. The accelerating nozzle 455, which has a step diameter of 4.2 mm 460 and exit orifice diameter of 2.64 mm 465, can provide additional focusing of the largest particles. This AFL has a designed flow rate of 0.1 L/min and the pressure before the first lens is 765 Pa.

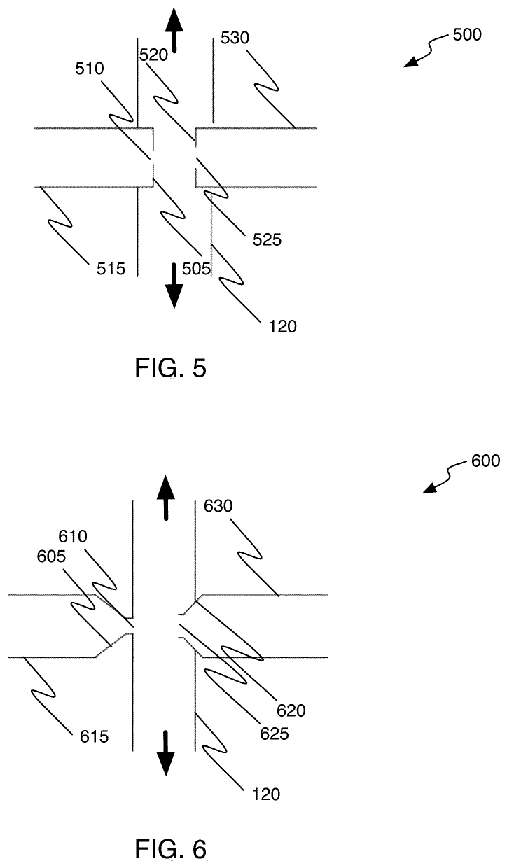

Referring now to FIG. 5, in some embodiments, simpler geometries are used. For example, the virtual impactor 500 can include one or more flat orifices, such as, for example, a flat orifice 505 inlet nozzle 510, an inlet tube 515, a flat orifice 520, a receiving nozzle 525, a receiving tube 530.

Referring now to FIG. 6, in some embodiments, the virtual impactor 600 can include one or more converging/diverging orifices, such as, for example, a converging orifice 605 inlet nozzle 610, an inlet tube 615, a diverging receiving orifice 620, a, receiving nozzle 625, and a receiving tube 630. In some instances, a converging inlet nozzle 605 can provide improved particle focusing. In some instances, a diverging, thin-walled receiving nozzle 625 can reduce flow and particle disturbance by the shockwave. In certain embodiments employing this geometry, there can be an increased likelihood of obtaining better particle enrichment as compared to a flat inlet and receiving orifices.

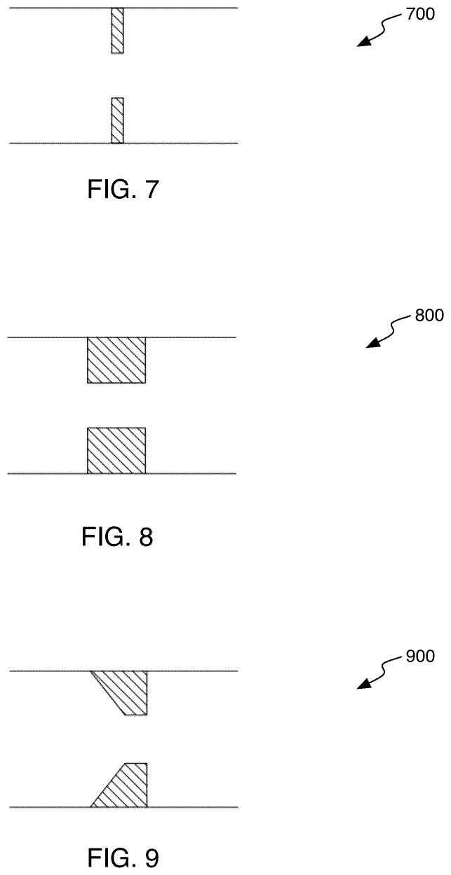

Referring now to FIG. 7, in some embodiments, the lens geometry of lenses in one or more lens groups can include one or more lenses incorporating a flat thin plate orifice 700. The orifice plate can be constructed of a mechanically strong material of a thickness that prevents or resists deformation. For example, lens design can include 0.25 mm (0.01 inch) plates made from metals such as, for example, stainless steel, brass, or aluminum, as well as from 3D-printable materials (such as electrically conductive material to prevent or resist charge accumulation). The diameter of the lens can be determined from the Stokes number of the target focusing size range.

Referring now to FIG. 8, in some embodiments, the lens geometry of lenses in one or more groups can include one or more lenses incorporating a short capillary (thick) orifice 800, such as, for example, with a thickness of 10 mm. The orifice thickness can slightly change the optimum Stokes number, where the orifice diameter, therefore, will be slightly different from the thin plate orifice. Short capillary orifices can be mechanically stronger than thin plate orifices. Materials can include, for example, metals such as stainless steel, brass, or aluminum, or 3D-printable materials.

Referring now to FIG. 9, in some embodiments, the lens geometry of lenses in one or more groups can include one or more lenses incorporating a conical orifice 900. The conical chamfer at the orifice inlet (e.g., 45°) can reduce the contraction of larger particles, preventing them from defocusing, or otherwise reducing the defocusing.

In some embodiments, the thin plate orifice lens are selected due, at least in part, to their simplicity. Short capillaries, but contrast, are mechanically stronger and less prone to deformation, but they can cause increased particle deposit inside the capillary, which can lead to clogging. The conical orifices can reduce defocusing of larger particles, but they can also require more precise machining.

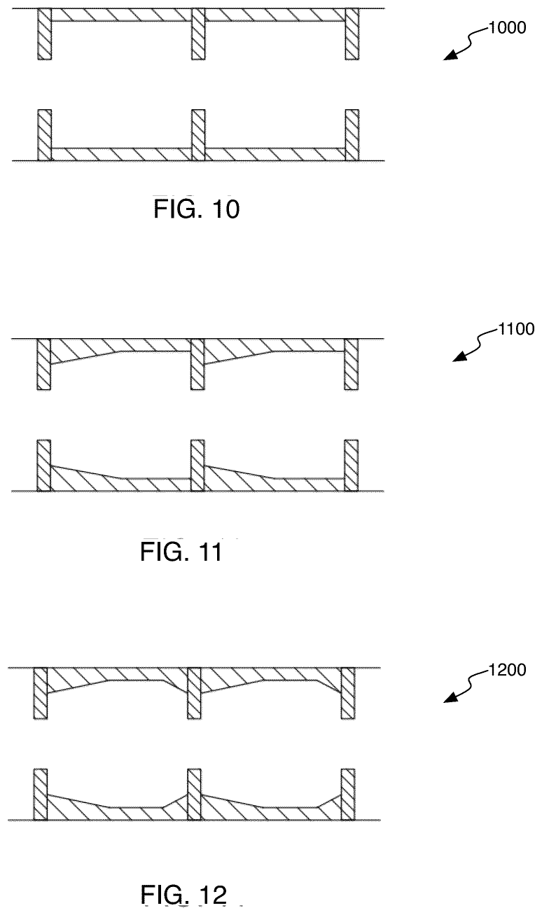

Referring now to FIG. 10, in some embodiments, the spacer geometries associated with one or more groups lens groups can include one or more cylindrical space geometries 1000. The spacers can be made of metals such as, for example, stainless steel, brass, or aluminum, as well as from 3D-printable materials. The inner diameter of the spacer can be greater than the neighboring lens diameters, often with the diameter ratio of spacers to lenses larger than 2. The spacers can prevent flow leaks between the lenses and the spacer, between the spacer and the lens housing, or both.

Referring now to FIG. 11, in some embodiments, the spacer geometries associated with one or more groups lens groups can include one or more divergent spacer space geometries 1100. The divergent spacer can guide the flow expansion downstream of the lens, which can reduce the flow recirculation behind the lens. The expansion angle can be determined, at least in part, from the flow reattachment length.

Referring now to FIG. 12, in some embodiments, the spacer geometries associated with one or more groups lens groups can include one or more divergent/convergent spacer space geometries 1200. The divergent/convergent spacer can reduce flow recirculation both upstream and downstream of the lenses. The expansion angle can be determined, at least in part, from the flow reattachment length, and the converging angle can be determined, at least in part, from the approaching length. The Aerodynamic Lens Calculator as described in Wang, X., & McMurry, P. H. (2006). A Design Tool for Aerodynamic Lens Systems. Aerosol Science and Technology, 40(5), 320-334 is incorporated herein by reference.

The cylindrical spacer is the easiest to machine and offer acceptable performance. The divergent spacer removes the large recirculation zone downstream of the lens, and the divergent/convergent spacer further removes the recirculation zone upstream of the lens. Therefore, in term of performance, the divergent/convergent spacer is preferred over the divergent spacer, which is preferred over cylindrical spacer. However, the machining difficulty is in the reverse order.

In some embodiments, one or more lenses and spacers are manufactured as an integrated component, reducing or eliminating the possibility of flow leak between the lens and spacer, simplifying lens alignment, or both.

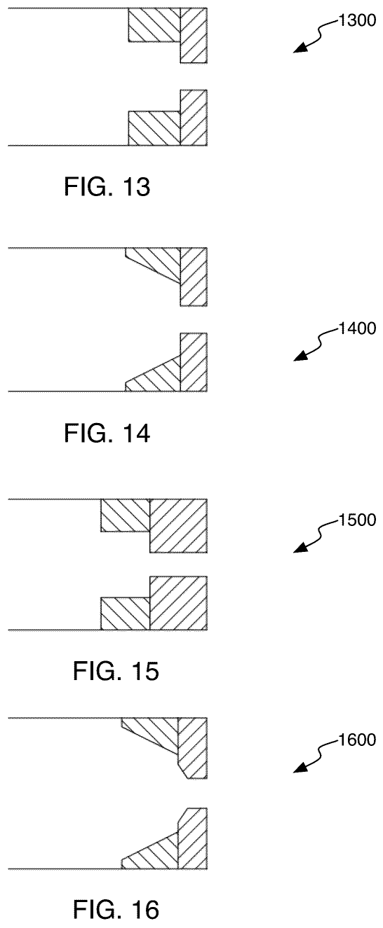

Referring now to FIG. 13, in some embodiments, the one or more nozzle geometries include a straight step and thin plate orifice geometry 1300. The nozzle step diameter (for example, half of the spacer inner diameter), can be designed to refocus a particle size range of interest. The exit diameter of the nozzle can be calculated based on lens operating pressure and flow rate. The nozzle can be made of metals such as, for example, stainless steel, brass, or aluminum, as well as from 3D-printable materials.

Referring now to FIG. 14, in some embodiments, the one or more nozzle geometries include a conical step and thin plate orifice geometry 1400. The conical step can reduce flow recirculation upstream of the orifice, reduce over-contraction of large particles, or both.

Referring now to FIG. 15, in some embodiments, the one or more nozzle geometries include a straight step and short capillary geometry 1500. The short capillary can reduce beam spread in the vacuum chamber as capillaries offer smaller divergence angles for wider particle size ranges.

Referring now to FIG. 16, in some embodiments, the one or more nozzle geometries include a conical step and conical orifice geometry 1600. The conical shapes can reduce over-contraction of larger particles.

The accelerating nozzle with a straight step and thin plate orifice is simple to construct. The alternative designs offer room to optimize in certain applications, although they are more difficult to machine precisely.

In some embodiments, the accelerating nozzle can serve as a focusing element. The step can bring particles, such as those of larger sizes, closer to the axis. Unlike conventional design that used specific dimensions of (step, nozzle) diameter combinations, e.g., (6, 3 mm) for Table 1 #1 AFL, (6, 2.76 mm) for Table 1 #2 AFL, and (7.6, 1.48 mm) for Table 1 #7 AFL, in some embodiments, the wide-size range AFL disclosed herein includes a step diameter approximately half of the preceding spacer inner diameter, regardless of the exit nozzle diameter. The particle beam shape and the acceleration speeds can be controlled, at least in part, by the acceleration nozzle. Downstream of the accelerating nozzle, particles travel in the vacuum chamber and can quickly reach their terminal velocities with certain expanding angle due to, at least in part, few collisions with gas molecules.

Terms of orientation used herein, such as “top,” “bottom,” “proximal,” “distal,” “longitudinal,” “lateral,” and “end,” are used in the context of the illustrated implementation. However, the present disclosure should not be limited to the illustrated orientation. Indeed, other orientations are possible and are within the scope of this disclosure.

Terms relating to circular shapes as used herein, such as diameter or radius, should be understood not to require perfect circular structures, but rather should be applied to any suitable structure with a cross-sectional region that can be measured from side-to-side. Terms relating to shapes generally, such as “circular,” “cylindrical,” “semi-circular,” or “semi cylindrical” or any related or similar terms, are not required to conform strictly to the mathematical definitions of circles or cylinders or other structures, but can encompass structures that are reasonably close approximations.

Conditional language, such as “can,” “could,” “might,” or “may,” unless specifically stated otherwise, or otherwise understood within the context as used, is generally intended to convey that certain implementations include or do not include, certain features, elements, and/or steps. Thus, such conditional language is not generally intended to imply that features, elements, and/or steps are in any way required for one or more implementations.

Conjunctive language, such as the phrase “at least one of X, Y, and Z.” unless specifically stated otherwise, is otherwise understood with the context as used in general to convey that an item, term, etc. may be either X, Y, or Z. Thus, such conjunctive language is not generally intended to imply that certain implementations require the presence of at least one of X, at least one of Y, and at least one of Z.

The terms “approximately,” “about,” and “substantially” as used herein represent an amount close to the stated amount that still performs a desired function or achieves a desired result. For example, in some implementations, as the context may dictate, the terms “approximately,” “about,” and “substantially,” may refer to an amount that is within less than or equal to 10% of the stated amount. The term “generally” as used herein represents a value, amount, or characteristic that predominantly includes or tends toward a particular value, amount, or characteristic. As an example, in certain implementations, as the context may dictate, the term “generally parallel” can refer to something that departs from exactly parallel by less than or equal to 20 degrees.

Unless otherwise noted, the terms “a” or “an,” as used in the specification are to be construed as meaning “at least one of.” In addition, for ease of use, the words “including” and “having,” as used in the specification, are interchangeable with and have the same meaning as the word “comprising.” In addition, the term “based on” as used in the specification is to be construed as meaning “based at least upon.”

Several illustrative implementations of a wide-size range AFL have been disclosed. Although this disclosure has been described in terms of certain illustrative implementations and uses, other implementations and other uses, including implementations and uses which do not provide all of the features and advantages set forth herein, are also within the scope of this disclosure. Components, elements, features, acts, or steps can be arranged or performed differently than described and components, elements, features, acts, or steps can be combined, merged, added, or left out in various implementations. All possible combinations and subcombinations of elements and components described herein are intended to be included in this disclosure. No single feature or group of features is necessary or indispensable.

Certain features that are described in this disclosure in the context of separate embodiments can also be implemented in combination in a single embodiment. Conversely, various features that are described in the context of a single implementation also can be implemented in multiple embodiments separately or in any suitable subcombination. Moreover, although features may be described above as acting in certain combinations, one or more features from a claimed combination can in some cases be excised from the combination, and the combination may be claimed as a subcombination or variation of a subcombination.

Any portion of any of the steps, processes, structures, and/or devices disclosed or illustrated in one implementation or example in this disclosure can be combined or used with (or instead of) any other portion of any of the steps, processes, structures, and/or devices disclosed or illustrated in a different implementation, flowchart, or example. The implementations and examples described herein are not intended to be discrete and separate from each other. Combinations, variations, and some implementations of the disclosed features are within the scope of this disclosure.

While operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Additionally, the operations may be rearranged or reordered in some implementations. Also, the separation of various components in the implementations described above should not be understood as requiring such separation in all implementations, and it should be understood that the described components and systems can generally be integrated together in a single product or packaged into multiple products. Additionally, some implementations are within the scope of this disclosure.

Further, while illustrative embodiments have been described, any implementations having equivalent elements, modifications, omissions, and/or combinations are also within the scope of this disclosure. Moreover, although certain aspects, advantages, and novel features are described herein, not necessarily all such advantages may be achieved in accordance with any particular implementation. For example, some implementations within the scope of this disclosure achieve one advantage, or a group of advantages, as taught herein without necessarily achieving other advantages taught or suggested herein. Further, some implementations may achieve different advantages than those taught or suggested herein.

Some implementations have been described in connection with the accompanying drawings. The figures are drawn and/or shown to scale, but such scale should not be limiting, since dimensions and proportions other than what are shown are contemplated and are within the scope of the disclosed invention. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various implementations can be used in all other implementations set forth herein. Additionally, any methods described herein may be practiced using any device suitable for performing the recited steps.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

In places where the description above refers to particular implementations of a wide-size range AFL, it should be readily apparent that a number of modifications may be made without departing from the spirit thereof and that these implementations may be applied to other a wide-size range AFLs. It will be understood that implementations are not limited to the specific components disclosed herein, as virtually any components consistent with the intended operation of a wide-size range AFL may be utilized. Components may comprise any shape, size, style, type, model, version, class, grade, measurement, material, weight, quantity, and/or the like consistent with the intended operation of a method and/or system implementation for a wide-size range AFL.

Clause 1. A wide-size range aerodynamic focusing lens, comprising: a virtual impactor comprising an inlet nozzle, a major flow tube, and a receiving nozzle; a plurality of grouped focusing elements comprising a first focusing lens element group, a refocusing lens element group, and a second focusing lens element group, and; and an accelerating nozzle.

Clause 2. The wide-size range aerodynamic focusing lens of clause 1, wherein the first focusing lens element group comprises one or more particle focusing lenses focusing a first size range particle.

Clause 3. The wide-size range aerodynamic focusing lens of clause 2, wherein the second focusing lens element group comprises one or more particle focusing lenses focusing a second size range particle.

Clause 4. The wide-size range aerodynamic focusing lens of clause 3, wherein the refocusing lens element group comprises one or more particle focusing lenses refocusing the first size range particle.

Clause 5. The wide-size range aerodynamic focusing lens of clause 1, wherein a particle enters the refocusing lens element group after passing through the first focusing lens element group and before entering the second focusing lens element group.

Clause 6. The wide-size range aerodynamic focusing lens of clause 1, wherein the accelerating nozzle comprises a step nozzle, the step nozzle comprising a step diameter equal to approximately half a preceding proximal spacer diameter.

Clause 7. The wide-size range aerodynamic focusing lens of clause 6, wherein the step is a large particle refocusing step.

Clause 8. The wide-size range aerodynamic focusing lens of clause 1, wherein the accelerating nozzle comprises a thin plate orifice exit.

Clause 9. The wide-size range aerodynamic focusing lens of clause 8, wherein the thin plate orifice exit is a small particle focusing exit.

Clause 10. A wide-size range aerodynamic focusing lens, comprising: a virtual impactor comprising an inlet nozzle, a major flow tube, and a receiving nozzle; a plurality of grouped focusing elements comprising a first focusing lens element group, a second focusing lens element group, and a refocusing lens element group, and a third focusing lens element group; and a plurality of spacers wherein a diameter ratio of a spacer proximal to a lens element is greater than or equal to 2 to and less than or equal to 20.

Clause 11. The wide-size range aerodynamic focusing lens of clause 10, wherein first focusing lens element group focuses a plurality of particles of larger size than the second focusing lens element group.

Clause 12. The wide-size range aerodynamic focusing lens of clause 11, wherein third focusing lens element group focuses a plurality of particles of smaller size than the second focusing lens element group.

Clause 13. The wide-size range aerodynamic focusing lens of clause 12, wherein the refocusing lens element group focuses a plurality of particles of similar size to the first focusing lens element group.

Clause 14. The wide-size range aerodynamic focusing lens of clause 11, wherein the plurality of particles comprises particles between 1,000 nm and 10,000 nm.

Clause 15. The wide-size range aerodynamic focusing lens of clause 12, wherein the plurality of particles comprises particles between 10 nm and 100 nm.

Clause 16. The wide-size range aerodynamic focusing lens of clause 11, wherein the second focusing lens element group focuses a plurality of particles comprising particles between 100 nm and 1,000 nm.

Clause 17. The wide-size range aerodynamic focusing lens of clause 13, wherein the plurality of particles comprises particles between 2,500 nm and 10,000 nm.

1. A wide-size range aerodynamic focusing lens, comprising:
a virtual impactor comprising an inlet nozzle, a major flow tube, and a receiving nozzle;
a plurality of grouped focusing elements comprising a first focusing lens element group, a refocusing lens element group, and a second focusing lens element group, and; and
an accelerating nozzle.

2. The wide-size range aerodynamic focusing lens of claim 1, wherein the first focusing lens element group comprises one or more particle focusing lenses focusing a first size range particle.

3. The wide-size range aerodynamic focusing lens of claim 2, wherein the second focusing lens element group comprises one or more particle focusing lenses focusing a second size range particle.

4. The wide-size range aerodynamic focusing lens of claim 3, wherein the refocusing lens element group comprises one or more particle focusing lenses refocusing the first size range particle.

5. The wide-size range aerodynamic focusing lens of claim 1, wherein a particle enters the refocusing lens element group after passing through the first focusing lens element group and before entering the second focusing lens element group.

6. The wide-size range aerodynamic focusing lens of claim 1, wherein the accelerating nozzle comprises a step nozzle, the step nozzle comprising a step diameter equal to approximately half a preceding proximal spacer diameter.

7. The wide-size range aerodynamic focusing lens of claim 6, wherein the step is a large particle refocusing step.

8. The wide-size range aerodynamic focusing lens of claim 1, wherein the accelerating nozzle comprises a thin plate orifice exit.

9. The wide-size range aerodynamic focusing lens of claim 8, wherein the thin plate orifice exit is a small particle focusing exit.

10. A wide-size range aerodynamic focusing lens, comprising:
a virtual impactor comprising an inlet nozzle, a major flow tube, and a receiving nozzle;
a plurality of grouped focusing elements comprising a first focusing lens element group, a second focusing lens element group, and a refocusing lens element group, and a third focusing lens element group; and
a plurality of spacers wherein a diameter ratio of a spacer proximal to a lens element is greater than or equal to 2 to and less than or equal to 20.

11. The wide-size range aerodynamic focusing lens of claim 10, wherein first focusing lens element group focuses a plurality of particles of larger size than the second focusing lens element group.

12. The wide-size range aerodynamic focusing lens of claim 11, wherein third focusing lens element group focuses a plurality of particles of smaller size than the second focusing lens element group.

13. The wide-size range aerodynamic focusing lens of claim 12, wherein the refocusing lens element group focuses a plurality of particles of similar size to the first focusing lens element group.

14. The wide-size range aerodynamic focusing lens of claim 11, wherein the plurality of particles comprises particles between 1,000 nm and 10,000 nm.

15. The wide-size range aerodynamic focusing lens of claim 12, wherein the plurality of particles comprises particles between 10 nm and 100 nm.

16. The wide-size range aerodynamic focusing lens of claim 11, wherein the second focusing lens element group focuses a plurality of particles comprising particles between 100 nm and 1,000 nm.

17. The wide-size range aerodynamic focusing lens of claim 13, wherein the plurality of particles comprises particles between 2,500 nm and 10,000 nm.
